(19) United States
(12) Patent Application Publication
(10) Pub. No.: US 2019/0333156 A1
(43) Pub. Date: Oct. 31, 2019

(54) DETERMINING VEHICULAR INSURANCE PREMIUM ADJUSTMENTS

(71) Applicant: Cubic Corporation, San Diego, CA (US)

(72) Inventors: William A. Malkes, Knoxville, TN (US); William S. Overstreet, Knoxville, TN (US); Jeffery R. Price, Knoxville, TN (US); Michael J. Tourville, Lenoir City, TN (US)

(21) Appl. No.: 16/394,997

(22) Filed: Apr. 25, 2019

Related U.S. Application Data
(60) Provisional application No. 62/664,022, filed on Apr. 27, 2018.

(51) Int. Cl. G06Q 40/08; G07C 5/00; G06K 9/00

(52) U.S. Cl. CPC G06Q 40/08; G06K 9/00785; G07C 5/008

(57) ABSTRACT

Systems and methods of determining a vehicular insurance premium adjustment are disclosed. Visual data of a roadway or intersection of roads is received from cameras positioned at a traffic signal indicators. The visual data is used to determine risk associated with the roadway or intersection of roads, in form of a risk score. The risk score associated with the route of an autonomous vehicle is compared to risk scores associated with risk scores of alternative routes. Further, the risk scores for alternative routes are sent to an insurance network for determining vehicular insurance premium adjustments associated with the risk scores.

### CROSS-REFERENCE TO RELATED APPLICATIONS

The present application claims the priority benefit of U.S. provisional application No. 62/664,022 filed Apr. 27, 2018 and entitled “Method of Determining Vehicular Insurance Premium Adjustments,” the disclosure of which is incorporated herein by reference.

### BACKGROUND OF THE INVENTION

### 1. Field of the Disclosure

The present disclosure generally relates to insurance premium adjustments for vehicles, and more particularly relates to insurance premium adjustments based on risks associated with vehicular routes.

### 2. Description of the Related Art

Vehicle or automobile insurance exists to provide financial protection against physical damage and/or bodily injury resulting from traffic accidents and against liability that may arise therefrom. Typically, a customer purchases a vehicular insurance policy for a premium rate with a specified term. The insurance policy may remain “in-force” while premium payments are made during the term or length of coverage of the policy as indicated in the policy. On the other hand, the insurance policy may “lapse” (or have a status or state of becoming “lapsed”), for example, when premium payments are not being paid or if the insured or the insurer cancels the policy.

In exchange for payments received from the customer, an insurer pays for damages to the customer, that may be caused by covered perils, acts, or events as specified by the language of the insurance policy. The payments received from the customer are generally referred to as premiums. The premiums are paid by the customer periodically. Typically, the premiums may be determined based on information such as, but not limited to, a selected level of insurance coverage, a location of vehicle operation, or vehicle model, or prior incidents involving vehicle operation. It should be noted that any change in the information may result in change in the premium. However, current premium method does not account for determining risks associated with autonomous vehicles.

Therefore, there is a need for an improved system and method for determining the risk associated with autonomous vehicles.

### SUMMARY OF THE CLAIMED INVENTION

Methods and systems for determining a vehicular insurance premium adjustment is presently claimed. The method begins by receiving data from cameras positioned at traffic signal indicates that are installed at a plurality of roadways or intersections. The data corresponds to accident data and route data. Then a current route for a vehicle is identified based on a current location of the vehicle and a pre-determined destination. Alternative routes for the vehicle are also identified from the current location of the vehicle ending at the pre-determined destination. Risks are calculated for each of the plurality of roadways or intersections associated with the current and alternative route of the vehicle whereby the calculated risk score is based on at least the accident data and the route data. A comparison of risk scores for each of the plurality of roadways or intersections associated with the current route of the vehicle with risk scores of the alternative routes is performed. The risk scores of the current route and the alternative routes are sent to the insurance network whereby the insurance network determines insurance premium adjustments based on the comparison between the risk scores of the current route and alternative routes.

A non-transitory computer-readable medium comprising instructions for performing a method of determining a vehicular insurance premium adjustment is also presently claimed. The method begins by receiving data from cameras positioned at traffic signal indicates that are installed at a plurality of roadways or intersections. The data corresponds to accident data and route data. Then a current route for a vehicle is identified based on a current location of the vehicle and a pre-determined destination. Alternative routes for the vehicle are also identified from the current location of the vehicle ending at the pre-determined destination. Risks are calculated for each of the plurality of roadways or intersections associated with the current and alternative route of the vehicle whereby the calculated risk score is based on at least the accident data and the route data. A comparison of risk scores for each of the plurality of roadways or intersections associated with the current route of the vehicle with risk scores of the alternative routes is performed. The risk scores of the current route and the alternative routes are sent to the insurance network whereby the insurance network determines insurance premium adjustments based on the comparison between the risk scores of the current route and alternative routes.

A system for determining a vehicular insurance premium adjustment is also presently claimed. The system includes a processor and a non-transitory computer-readable medium storing instructions, that when executed by the processor, cause the system to receive data from cameras positioned at traffic signal indicates that are installed at a plurality of roadways or intersections. The data corresponds to accident data and route data. Then the system identifies a current route for a vehicle based on a current location of the vehicle and a pre-determined destination. Alternative routes for the vehicle are also identified by the system from the current location of the vehicle ending at the pre-determined destination. The system then calculates risk scores for each of the plurality of roadways or intersections associated with the current and alternative route of the vehicle whereby the calculated risk score is based on at least the accident data and the route data. A comparison of risk scores for each of the plurality of roadways or intersections associated with the current route of the vehicle with risk scores of the alternative routes is performed by the system. The risk scores of the current route and the alternative routes are then sent to the insurance network whereby the insurance network determines insurance premium adjustments based on the comparison between the risk scores of the current route and alternative routes.

### BRIEF DESCRIPTION OF THE DRAWINGS

FIG. 1 illustrates an exemplary network connection diagram 100 of a smart traffic system for determining an insurance premium adjustment.

FIG. 2 is a block diagram illustrating different components of an exemplary smart traffic system.

FIG. 3 is a flowchart illustrating an exemplary method performed by the smart traffic signal base module.

FIG. 4 is a flowchart illustrating an exemplary method performed by the smart traffic signal network base module.

FIG. 5 is a flowchart illustrating an exemplary method performed by the smart traffic signal network accident risk module 212.

FIG. 6 is a flowchart illustrating an exemplary method performed by the smart traffic signal network autonomous vehicle route module 214.

FIG. 7 is a flowchart illustrating an exemplary method performed by the autonomous vehicle base module 108.

FIG. 8 is a flowchart illustrating an exemplary method performed by the insurance network underwriting module 216.

FIG. 9 is a flowchart illustrating an exemplary method performed in the method for determining an insurance premium adjustment.

### DETAILED DESCRIPTION

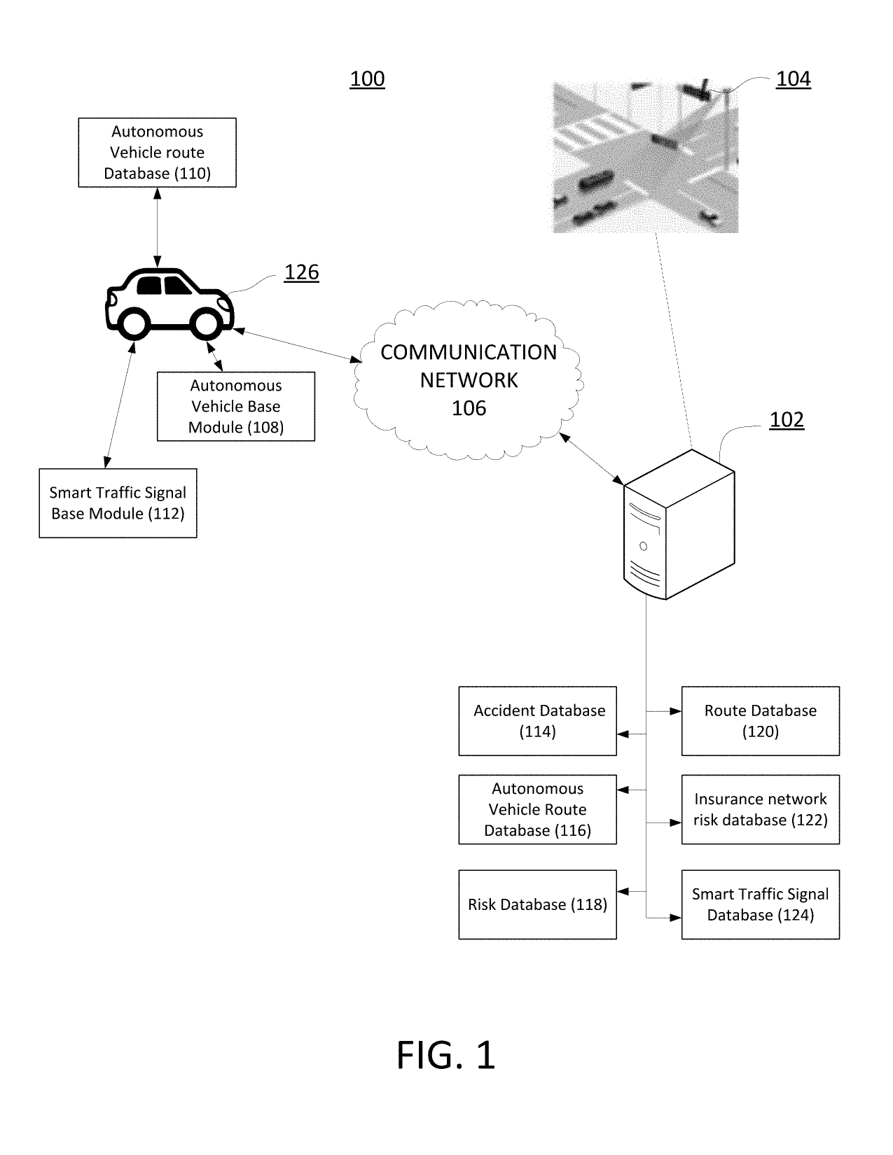

FIG. 1 illustrates an exemplary network connection diagram 100 of a smart traffic system 102 for determining an insurance premium adjustment. In a first embodiment, the smart traffic system 102 may be implemented at a traffic control cabinet installed on a roadway or at an intersection of roads. A further embodiment may have the smart traffic system 102 be implemented as an application running over a cloud network. The smart traffic system 102 may be connected with a plurality of cameras positioned at several locations along the road or the intersection of roads. A single camera 104 is shown to be present at the intersection of roads, as illustrated in FIG. 1. The camera 104 according to the present invention may be configured to capture visual data of vehicles passing through the intersection of roads or passing along some roadway. Furthermore, the exemplary embodiment, as illustrated in the figure, is compatible with autonomous vehicles 126. It should be noted that the embodiment of FIG. 1 is also compatible with non-autonomous vehicles (i.e. manually driven vehicles) by making appropriate modifications to the disclosed functions.

The smart traffic system 102 may be connected to a communication network 106 that facilitates communication between the autonomous vehicle 126 and the smart traffic system 102 The communication network 106 allows the smart traffic system 102 to connect with, for example, the autonomous vehicle base module 108, autonomous vehicle route module 110, and smart traffic cabinet base module 112 associated with the autonomous vehicle 126. The communication network 106 may be a wired and/or a wireless network. The communication network 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

The smart traffic system 102 may comprise various different databases 114-124. Exemplary databases include the smart traffic system 102 may be connected to an accident database 114, an autonomous vehicle route database 116, risk database 118, a route database 120, an insurance network risk database 122, and a smart traffic signal database 124. Further details regarding each of the element 108-124, as illustrated in FIG. 1, are provided below in the next figures.

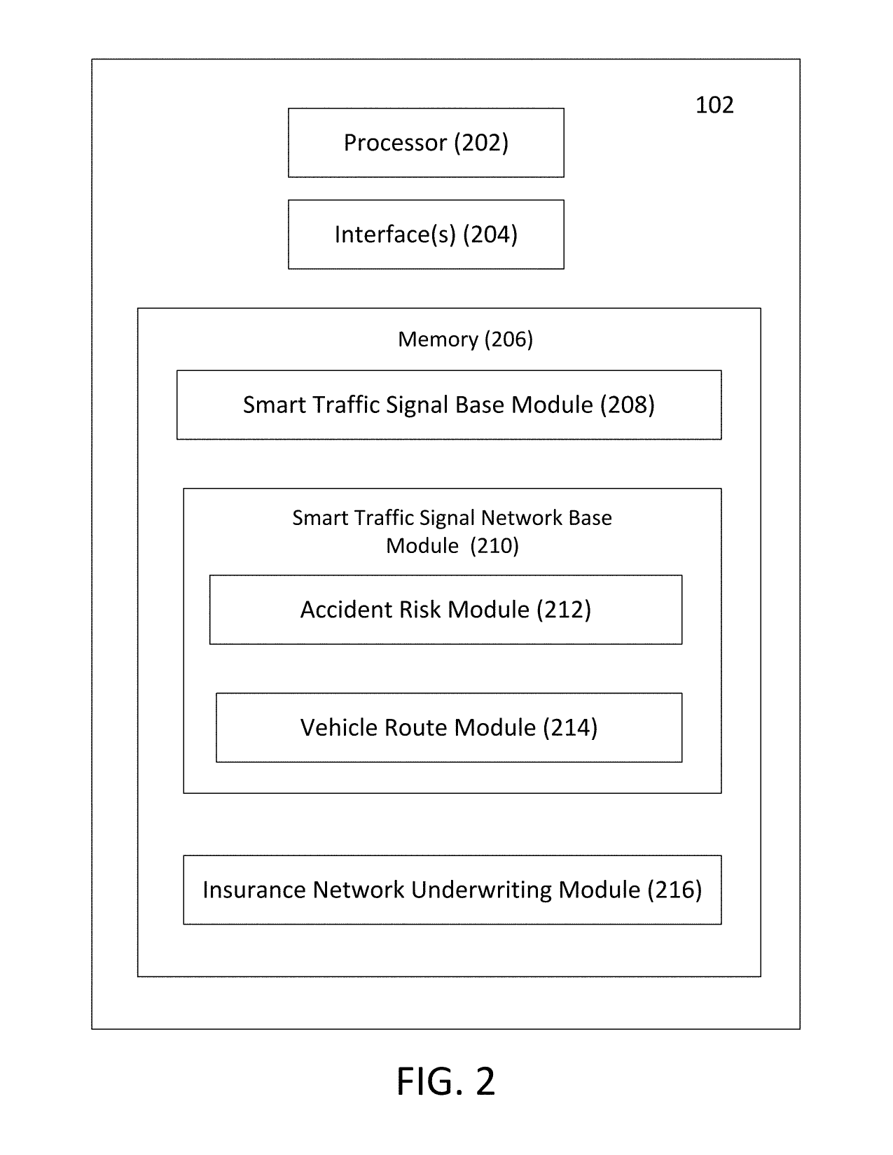

FIG. 2 illustrates a block diagram showing different components of the smart traffic system illustrated in FIG. 1. The smart traffic system 102 of FIG. 1 comprises a processor 202, interface(s) 204, and memory 206. The processor 202 may execute an algorithm stored in the memory 206 for determining visual details of an intersection or roadway. The processor 202 may also be configured to decode and execute any instructions received from one or more other electronic devices or server(s). The processor 202 may include one or more general-purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 202 may be configured to execute one or more computer-readable program instructions, such as program instructions to carry out any of the functions described in this description.

The interface(s) 204 may help an operator to interact with the smart traffic system 102. The interface(s) 204 of the smart traffic system 102 may either accept an input from the operator or provide an output to the operator, or may perform both the actions. Exemplary interface(s) 204 include Command Line Interfaces (CLI), Graphical User Interfaces (GUI), and voice interfaces. Other interface(s) are also possible and would be compatible with the smart traffic system 102.

The memory 206 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 206 may comprise various modules implemented as a program. In one case, the memory 206 may comprise (as illustrated in FIG. 2) a smart traffic signal base module 208, a smart traffic signal network base module 210, an accident risk module 212, a vehicle route module 214, and an insurance network underwriting module 216. Other modules may also be possible and compatible with the program associated with the memory 206 as illustrated in FIG. 2.

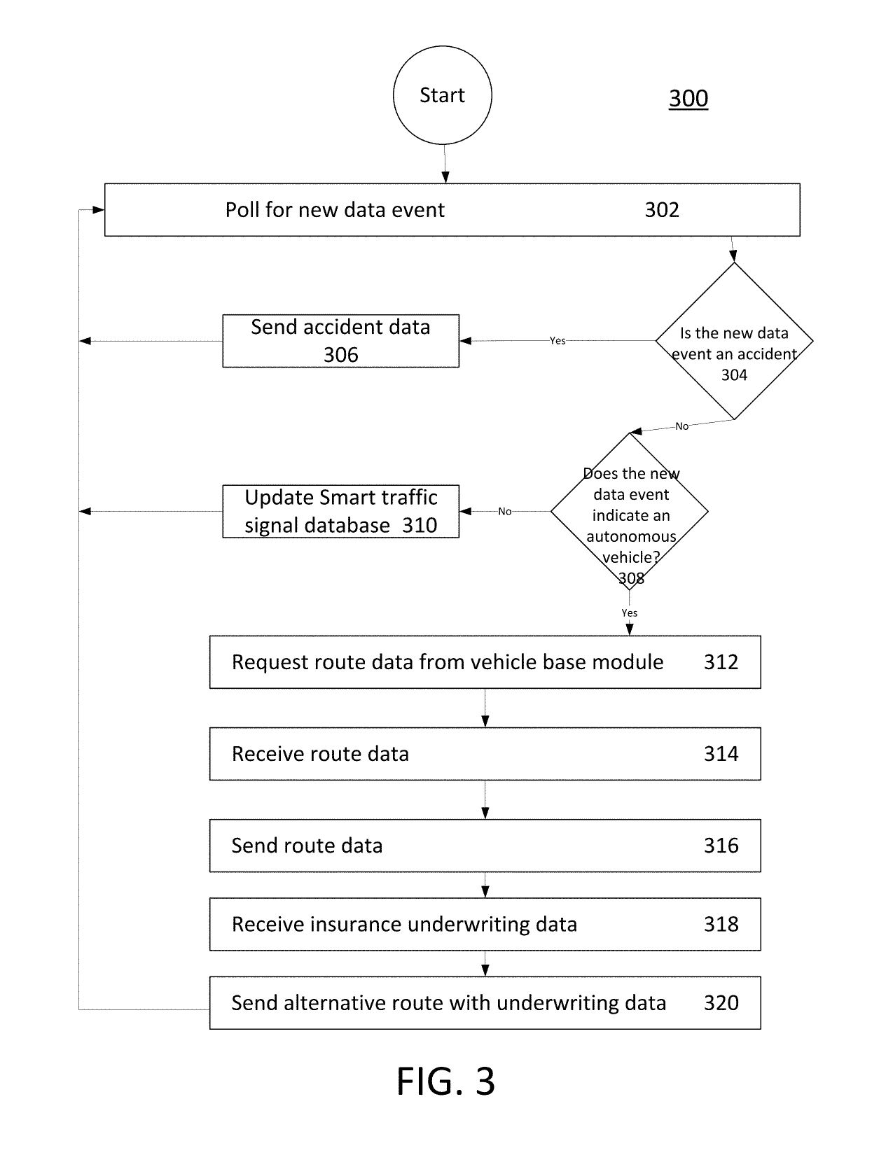

Functioning of the smart traffic signal base module 208 (as illustrated in FIG. 2) will now be explained with reference to FIG. 3. In particular, FIG. 3 is a flowchart illustrating an exemplary method 300 performed by the smart traffic signal base module 208. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

At first, the smart traffic signal base module 208 polls the cameras 104 overseeing the intersection of roads and/or the roadway for a new data event, at step 302. The camera 104 used may include, but not limited to, fish-eye camera, Closed Circuit Television (CCTV) camera, and infrared camera. Further, sensors such as induction loops may also be used along with the camera 104.

Successively, the new data event is assessed to determine if the new data event is an accident, at step 304. One possible outcome could be that the new event data obtained in step 302 corresponds with an accident. Upon such determination (via step 304), the accident data would be sent to the smart traffic signal base module 208 at step 306. Thereafter, the smart traffic signal base module 208 resumes polling for a new data event (thereby repeating step 302).

If the new event data is not identified to be an accident (in step 304), the new event data is subsequently assessed if the new data event corresponds to an autonomous vehicle 126 entering an intersection, at step 308. One possible outcome of step 308 is that the new data event is not associated with an autonomous vehicle 126. If not, the new data can be used to update the smart traffic signal base module 208 in step 310. Afterwards, the smart traffic signal base module 208 can resume polling for new data events (repeating step 302 again).

However, if the new event data does correspond to an autonomous vehicle, the smart traffic signal base module 208 next requests route data from the autonomous vehicle base module 108, at step 312. The smart traffic signal base module 208 can then receive the requested route data from the autonomous vehicle base module 108, at step 314. It may be assumed that the autonomous vehicle base module 108 returns the requested route data under the standards and regulations developed for autonomous vehicle operation with regards to communication with infrastructure. If the data is not returned from the autonomous vehicle 126, the smart traffic signal base module 208 resumes polling for new data events.

Assuming the route data is received from the autonomous vehicle 126 in step 314, the smart traffic system 102 subsequently sends the route data to the smart traffic signal network base module 210, at step 316. After sending the route data, insurance underwriting data (from the insurance network underwriting module 216) is received at step 318.

Thereafter, alternate routes (i.e. route data) and the insurance underwriting data are communicated to the autonomous vehicle base module 108, at step 320. After sending the alternate routes and the insurance underwriting data, the smart traffic signal base module 208 resumes polling for new data events (repeating step 302). If the new data event was neither an accident nor the autonomous vehicle 126 entering the intersection, the smart traffic signal database 124 is updated (as described above in step 310). It should be noted that the data stored within the smart traffic signal database 124 includes data required for traffic management, such as vehicle position, speed, quantity, and timing.

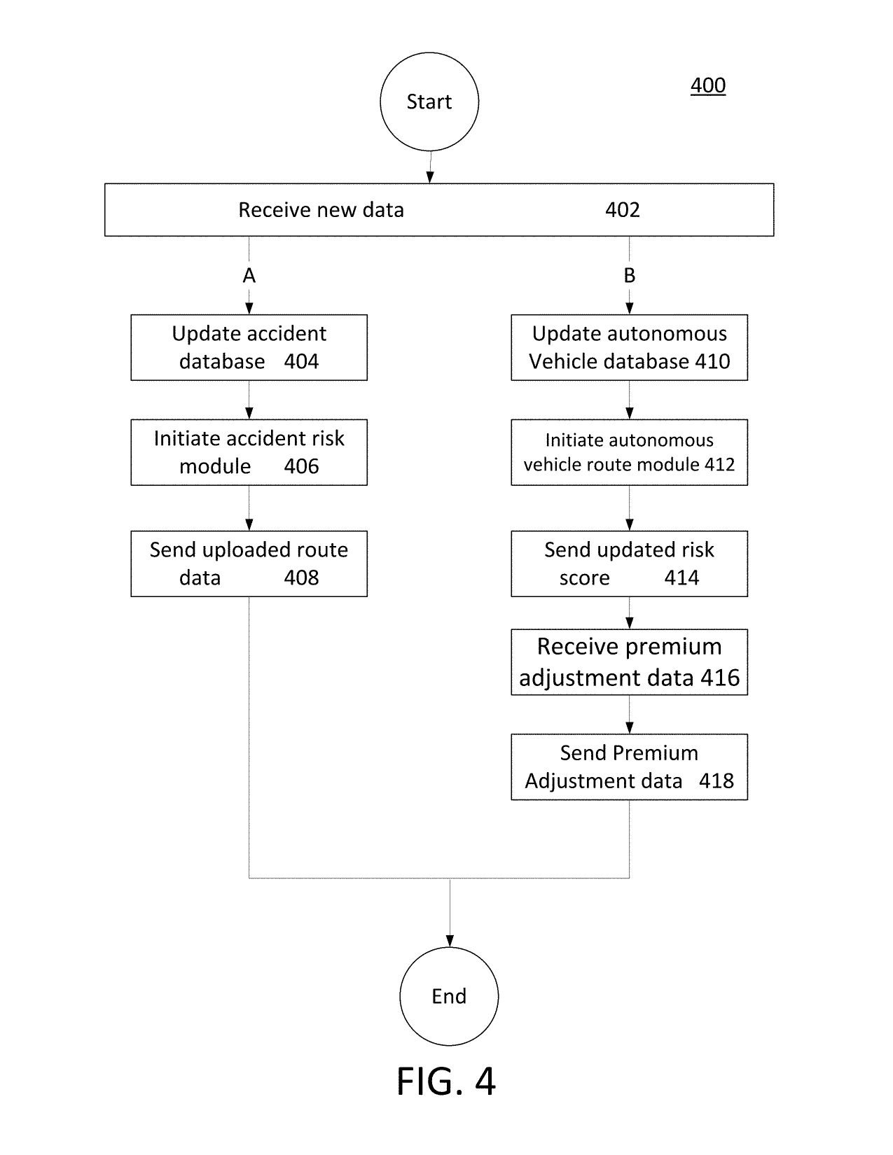

Functioning of the smart traffic signal network base module 210 (as illustrated in FIG. 2) will now be explained with reference to FIG. 4. In particular, FIG. 4 is a flowchart illustrating an exemplary method 400 performed by the smart traffic signal network base module 210. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

At first, the smart traffic signal network base module 210 receives new data from the smart traffic signal base module 208, at step 402. The new data may be accident data or route data, received from the autonomous vehicle 126 of FIG. 1. In one case, while the new data is accident data (A), the smart traffic signal network accident database 114 is updated, at step 404. The smart traffic signal network accident database 114 stores a table for each intersection of roads or roadway along with a record of accidents observed at each of those intersection of roads or roadway.

Further, the smart traffic system 102 initiates the smart traffic signal network accident risk module 212 to calculate a new risk score for the intersection or roadway, at step 406. In one embodiment, the new risk score is calculated based on a number of accidents per 100 vehicles that pass through the intersection or along the roadway. The accidents are also be weighted based upon severity—with the more serious accidents being weighted more heavily than minor accidents. The updated route data based upon the calculated new risk score is sent to the smart traffic signal network risk database 118 and the insurance network underwriting module 216, at step 408.

In another case, if the new data corresponds to autonomous vehicle route data (B), the smart traffic signal base module 208 updates and stores the route data for the autonomous vehicle in the smart traffic signal network autonomous vehicle database 116, at step 410. The smart traffic cabinet network autonomous vehicle route module 214 is then initiated, at step 412.

The smart traffic signal autonomous vehicle route module 214 calculates the total risk score of all intersections or roadways the autonomous vehicle 126 traverses along its current route to a pre-determined destination. Furthermore, the smart traffic signal autonomous vehicle route module 214 also compares the calculated total risk score with the total risk score of available alternative routes that the autonomous vehicle can take to reach the same destination. The risk scores of the available routes are communicated to the insurance network underwriting module 216, at step 414.

Furthermore, the risk scores of the available route are communicated to the insurance network underwriting module 216. The risk scores for the available routes would be used to update an underwriting criteria and communicate the premium adjustment associated with each available route, at step 416. The premium adjustment data is then sent to the smart traffic signal base module 208, at step 418.

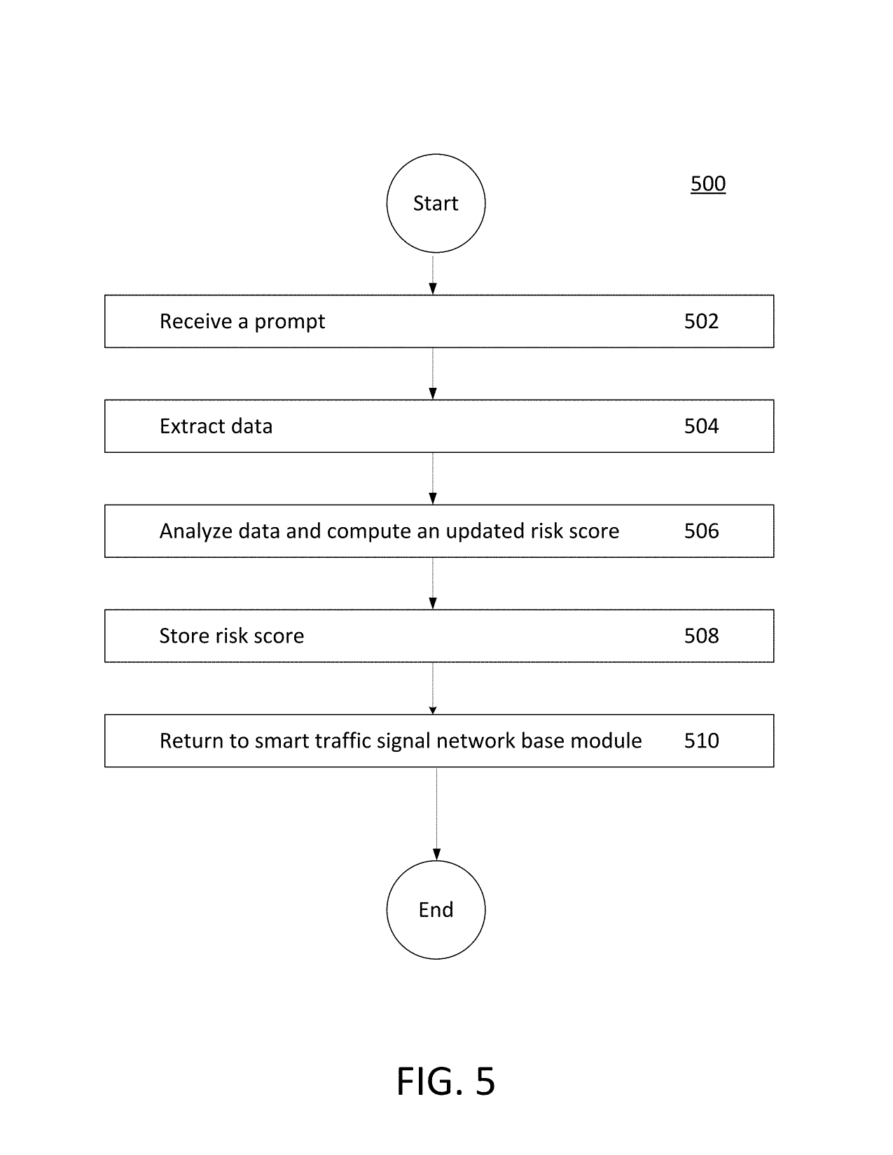

FIG. 5 is a flowchart illustrating an exemplary method 500 performed by the smart traffic signal network accident risk module 212. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

At first, the smart traffic signal network accident risk module 212 receives a prompt from the smart traffic signal network base module 210, at step 502. Data related to a smart traffic light that is reported as an accident is extracted from the smart traffic signal network accident database 114, at step 504.

Successively, the data is analyzed to compute an updated risk score for the smart traffic signal, at step 506. In one scenario, the risk score is weighted average of the number of accidents per 1000 vehicles that passes through the intersection of roads or on the roadway. The weighting depends on accident severity, with severity defined, for example, into three categories (e.g. minor, moderate, and severe). In an embodiment, a minor accident is weighted with a value of 1, a moderate accident is weighted with a value of 3, and a severe accident is weighted with a value of 5. Thus, if one intersection of roads had 3 accidents, with one accident in each category, the calculated risk score out of 1000 vehicles would be 9 (1+3+5).

Successively, the risk score is stored in the smart traffic signal network risk database 118, at step 508. The control is then be returned to the smart traffic signal network base module 210, at step 510. The program for calculating the risk score then ends.

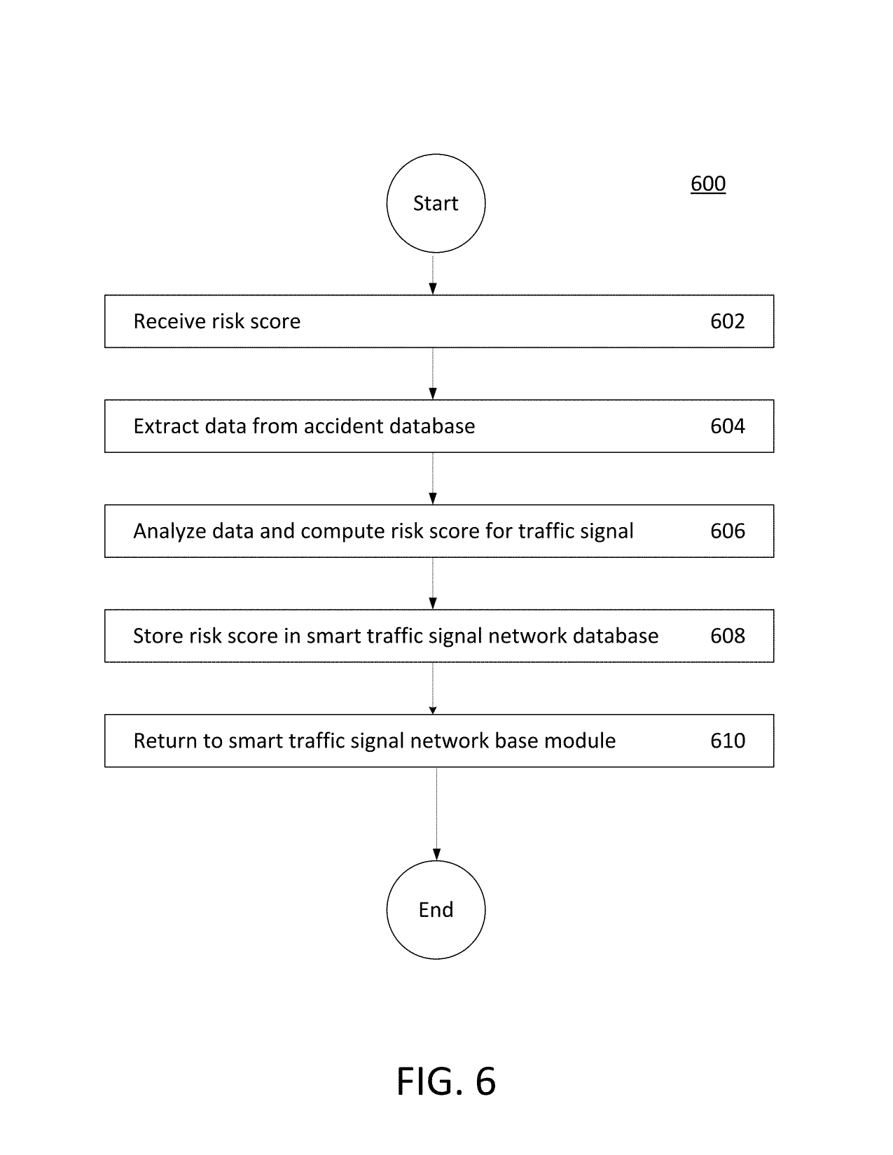

FIG. 6 is a flowchart illustrating an exemplary method 600 performed by the smart traffic signal network autonomous vehicle route module 214. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

At first, the smart traffic signal network autonomous vehicle route module 214 is initiated based on a prompt received from the smart traffic signal network base module 210 (e.g. start). Further, a risk score is also received, at the step 602. The risk score is extracted for the intersection of roads along with the received route from the smart traffic signal network risk database 118, at step 604. The total risk score for the received route is calculated.

An alternate route from the current intersection to a destination of the autonomous vehicle 126 is identified from the smart traffic signal network risk database 118. The total risk score for available alternate routes is then be calculated, at step 606.

Further, the calculated risk score for all available routes is stored in the smart traffic signal network risk database 118, at step 608. The smart traffic system 102 then returns control to the smart traffic signal network base module 210, at step 610.

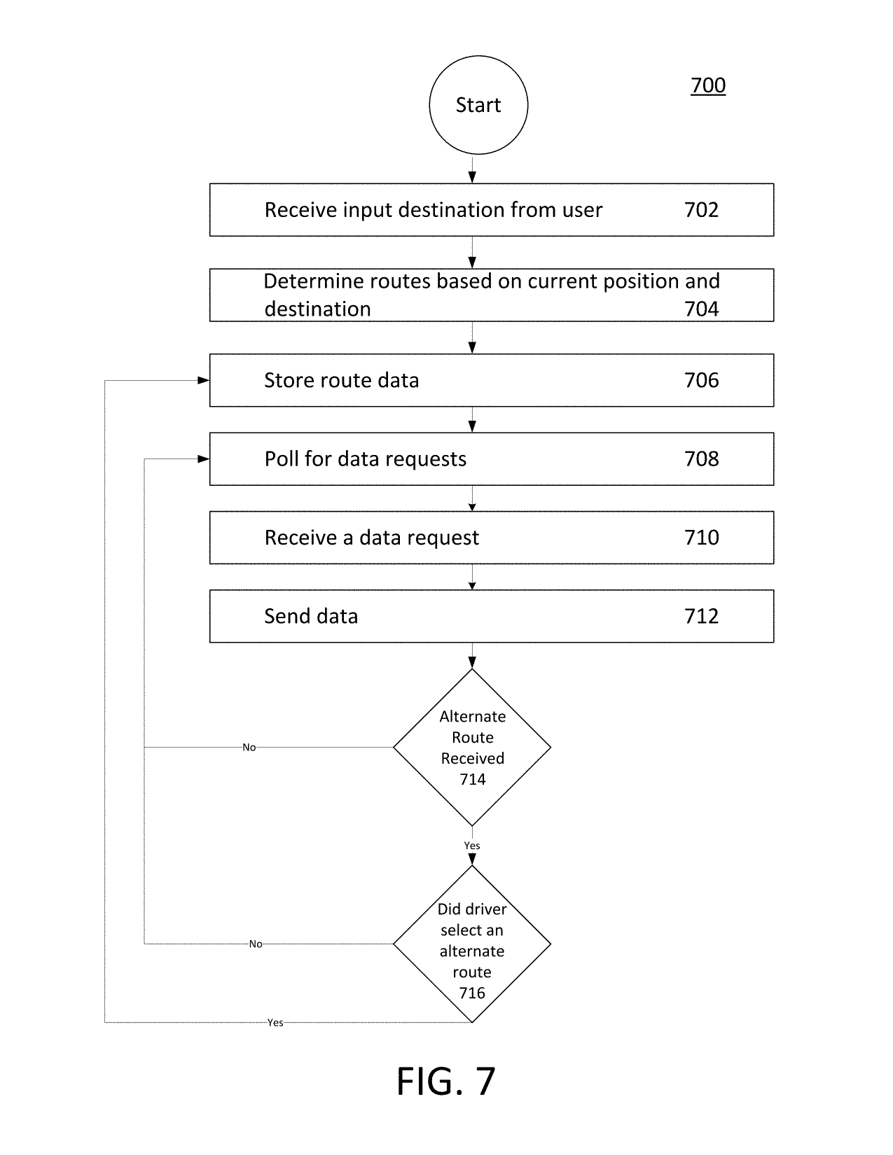

FIG. 7 is a flowchart illustrating an exemplary method 700 performed by the autonomous vehicle base module 108. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

At first, an input for a destination is received from a user of the autonomous vehicle 126, at step 702. A route for the autonomous vehicle 126 is determined based on a current position and a destination of the vehicle, at step 704. The possible routes depend on the current location of the autonomous vehicle 126 and on third party navigation services such as Google Maps. Route data of a selected route are stored in the autonomous vehicle route database 110, at step 706. Successively, polling for data requests begins, at step 708. A data request is received from the smart traffic signal base module 208 for routes stored in the autonomous vehicle route database, at step 710.

The requested data is sent to the smart traffic signal base module 208, at step 712. The smart traffic system 102 polls to determine if an alternative route is received from the smart traffic signal network autonomous vehicle route module 214, at step 714. The user selects to take the alternate route, at step 716. The information of the selected alternate route, is sent to the autonomous vehicle route database 110 (repeat step 706). If the user selects to stay on the current route, however, polling for data requests are continued (repeat step 708).

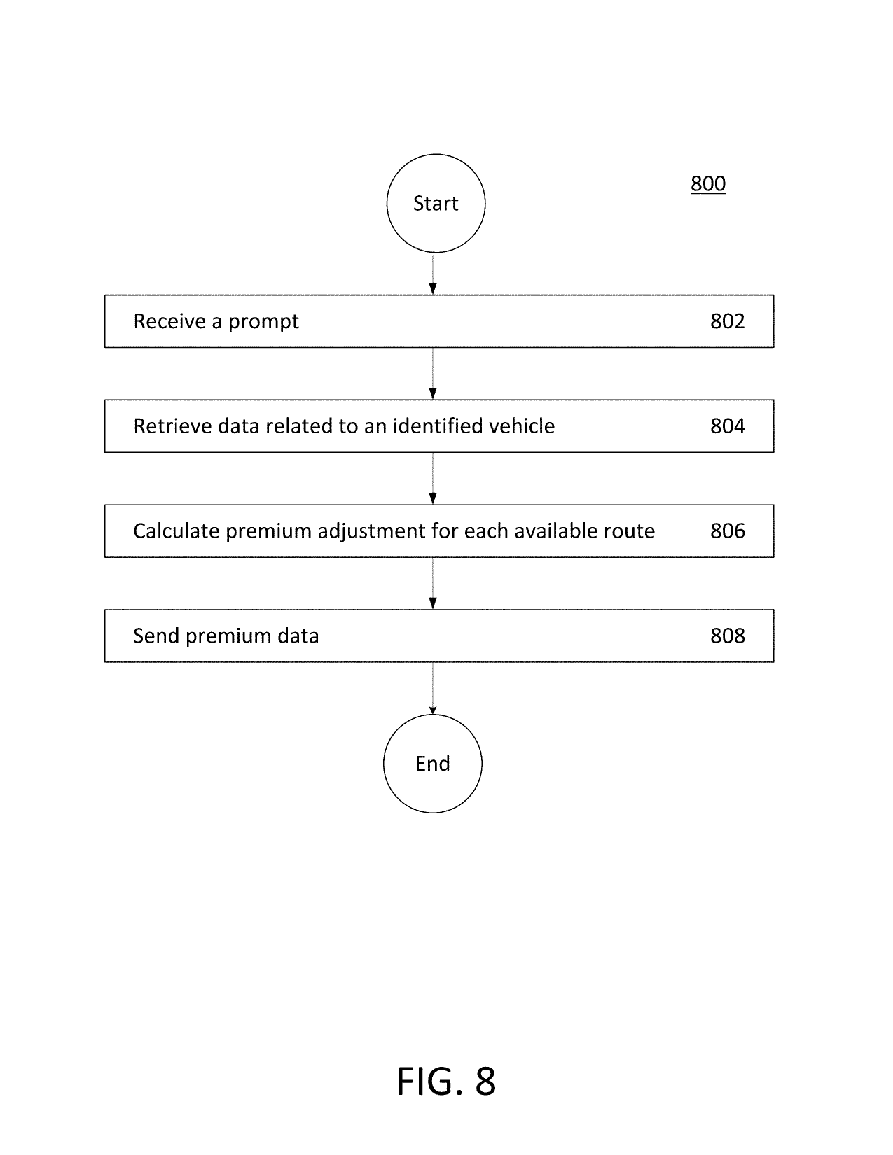

FIG. 8 is a flowchart illustrating an exemplary method 800 performed by the insurance network underwriting module 216. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

At first, the insurance network underwriting module 216 receives a prompt from the smart traffic signal network base module 210, at step 802. Data related to an identified autonomous vehicle 126 is retrieved, at step 804. The data includes, for example, a current route, available alternate routes, risk score for each route, insurance rates, and underwriting criteria related to the identified vehicle. The data related to the identified autonomous vehicle 126 is then used to calculate the premium adjustment for each available route, at step 806. The premium adjustment determined for each route is sent to the smart traffic signal network base module 210, at step 808.

Table 1, shown below, illustrates an exemplary representation of data stored in the smart traffic signal database 124. The smart traffic signal database 124 contains, for example, data captured by the smart traffic signal. The top row represents unique intersection/road identifiers and traffic signal identities for labelling each traffic signal out of a plurality of traffic signals positioned at the corresponding roads and intersections of roads. For example, NS represents traffic signal controlling the traffic in North-to-South direction. Column one represents the time stamp when the image of the intersection were taken. Column two represents the image data captured using the camera 104. Analysis of the images or video feed of the camera 104 may give many data points which may be related to adverse events such as accidents. Column three contains indications for such data events identified from the camera feed. Mainly two types of data events are analysed, one may be accident and other may be presence of autonomous vehicle 126 travelling towards an intersection. Other data events may also be present, such as vehicle position, speed, quantity, timing, and the like.

TABLE 1
Intersection/Road ID - X123, Traffic Cabinet ID - NS

| Time Stamp | Image File | Data Event |
|---|---|---|
| 10/14/2017 10:30:00 | Img1.dat | Accident |
| 10/14/2017 10:31:10 | Img1.dat | Autonomous Vehicle |
| 10/14/2017 10:31:50 | Img1.dat | Pedestrian |
| 10/14/2017 10:30:00 | Img1.dat | High Volume Traffic |
| 10/14/2017 10:31:10 | Img1.dat | Emergency Vehicle |
| . . . | . . . | . . . |
| 10/14/2017 10:31:10 | ImgN.dat | Accident |

Table 2, shown below, illustrates an exemplary representation of data stored in the smart traffic signal network accident database 114. Column one represents a unique intersection/road identifier. Column two represents the traffic signal identifiers for labelling each traffic signal out of the plurality of traffic signals positioned at corresponding roads or intersections of roads. For example, NS represents traffic signal controlling the traffic in north-to-south direction. Column three represents the time stamp of the accident data received from the smart traffic signal. Column four represents an indication of severity of the accidents, for example, in three categories—Minor, Moderate and Severe. For example, a major accident may be defined where multiple vehicles got involved or where accident impact lead to fatal injuries. In contrast, a minor accident may be defined as an accident limited in extent and damages. The definitions can be customized. Furthermore, the indications that an accident has a particular severity may be derived using machine vision algorithms on the camera feed or obtained from post-accident reports from various public or third-party data sources.

TABLE 2

| Intersection/ | Traffic | | Accident |
|---|---|---|---|
| Road ID | Cabinet ID | Time Stamp | Severity |
| X123 | NS | 06/14/2017 10:30:00 | Minor |
| A345 | NS | 12/18/2017 10:31:10 | Moderate |
| F785 | NS | 03/08/2017 10:31:50 | Moderate |
| V098 | EW | 02/14/2017 10:30:00 | Severe |
| D345 | EW | 10/01/2017 10:31:10 | Minor |
| . . . | . . . | . . . | . . . |
| H456 | NS | 10/14/2017 10:31:10 | Moderate |

Table 3, shown below, illustrates an exemplary representation of data stored in the smart traffic signal network risk database 118. Column one represents unique intersection/roadway identifiers. Column two represents the traffic signal identities for labelling each traffic signal out of the plurality of traffic signals positioned at the corresponding intersection/road. Column three represents the overall risk score for the specific smart traffic signal and intersection/roadway by calculation of a risk weighted average of the accident related data stored in the smart traffic signal network accident database. The weighting depends on accident severity, with severity broken into three categories, minor, moderate and severe. A minor accident is represented as 1, a moderate accident as 3 and a severe accident as 5. In case, one intersection had 3 accidents, one in each category, out of 1000 vehicles the risk score would be 9 (1+3+5) per 1000. That risk score is stored in the smart traffic signal risk database.

TABLE 3

| Intersection/ | Traffic | Overall Risk Score in |
|---|---|---|
| Road ID | Cabinet ID | Accidents per 1000 vehicles |
| X123 | NS | 9 |
| A345 | NS | 11 |
| F785 | NS | 13 |
| V098 | EW | 2 |
| D345 | EW | 24 |
| . . . | . . . | . . . |

Table 4, shown below, illustrates an exemplary representation of data stored in the smart traffic cabinet network autonomous vehicle route database 120. Column one represents the unique autonomous vehicle ID. Column two represents the route identifier for uniquely identifying each route request by the autonomous vehicle 126. The updates suggested by the smart traffic cabinet network to the autonomous vehicle 126 are stored with same route id with different time stamp. Column three represents the time stamp of collection of route data from the autonomous vehicle 126. Column four represents the route file which contains geocoded information of starting point and final destination along with intermediate points in the route.

TABLE 4

| Autonomous | | | |
|---|---|---|---|
| Vehicle ID | Route ID | Time Stamp | Route Data File |
| VIN1234 | 1 | 10/14/2017 10:30:00 | Route Data1.dat |
| VIN1234 | 1 | 10/14/2017 10:31:10 | Route Data1.dat |
| VIN1233 | 2 | 10/14/2017 10:31:50 | Route Data2.dat |
| VIN9876 | 3 | 10/14/2017 10:30:00 | Route Data3.dat |
| VIN0675 | 4 | 10/14/2017 10:31:10 | Route Data4.dat |
| . . . | . . . | . . . | . . . |
| VINXXXX | N | 10/14/2017 10:31:10 | Route DataN.dat |

Table 5, shown below, illustrates an exemplary representation of data stored in the autonomous vehicle route database 110. The top row indicates the unique autonomous vehicle ID. Column one represents the route identifier for uniquely identifying each route taken by the autonomous vehicle 126 on the roads. Column two represents the time stamp of storing of route data from the autonomous vehicle base module. Alternative Routes suggested by the smart traffic cabinet network are stored in this database if the user or autonomous vehicle 126 approves the newly suggested route. Column three represents the route file which contains geocoded information of starting point and final destination along with intermediate points in the route.

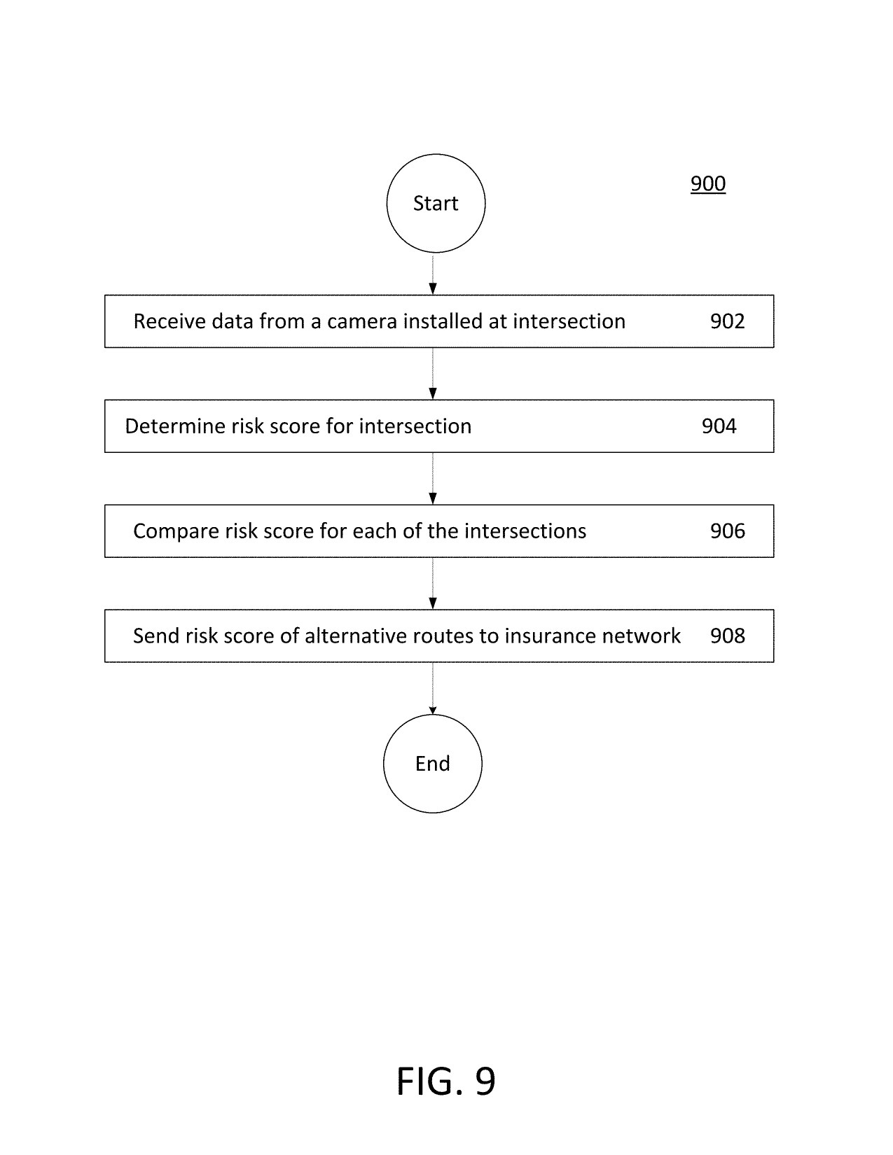

FIG. 9 is a flowchart illustrating an exemplary method 900 performed in the method for determining an insurance premium adjustment. In this regard, each block represents a module, segment, or portion of code, which comprises one or more executable instructions for implementing the specified logical function(s). It should also be noted that in some alternative implementations, the functions noted in the blocks occur out of the order noted in the drawings. For example, two blocks shown in succession in FIG. 9 may, in fact, be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 900 starts at step 902 and proceeds to step 908.

At step 902, data is received from a camera 104 positioned at a traffic signal indicator, installed at an intersection of roads or along a roadway. The camera 104 used may include, but not limited to, fish-eye camera, closed circuit television (CCTV) camera, and infrared camera. Further, sensors such as induction loops may also be used along with the camera 104.

At step 904, the risk score for all intersections of roads or roadways associated with a current route of an autonomous vehicle 126 is determined. The smart traffic cabinet network base module 210 updates the smart traffic cabinet network accident database 114 based on the accident data and initiates the smart traffic cabinet network accident risk module 212. The smart traffic cabinet network accident risk module 212 calculates risk score at the traffic signal for which accident data is received. In one embodiment, the risk score may be a severity-weighted score.

At step 906, the risk score calculated for all intersections of roads is compared with risk scores of alternative routes. The alternative routes are determined to start from a current location of the autonomous vehicle 126 a destination.

At step 908, the risk score of alternative routes is sent to an insurance network. The available routes and the premium adjustments associated with each available route are communicated to the autonomous vehicle 126.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method of determining a vehicular insurance premium adjustment, the method comprising:
receiving data from cameras positioned at traffic signal indictors installed at a plurality of roadways or intersections, wherein the received data corresponds to at least one instance of accident data and route data;
identifying a current route of a vehicle based on a current location of the vehicle and an identified destination;
identifying one or more alternative routes for the vehicle, wherein the alternative routes are determined to start from the current location of the vehicle and end at the identified destination;
calculating risk scores for each of the plurality of roadways or intersections associated with the current route and alternative routes of the vehicle, wherein the calculated risk score for each of the plurality of roadways or intersections is based at least on the accident data and the route data;
comparing the risk scores for each of the plurality of roadways or intersections associated with the current route of the vehicle with risk scores for the alternative routes; and
sending a report regarding the risk scores of the current route and the alternative routes to an insurance network, wherein the insurance network determines vehicular insurance premium adjustments associated with the comparison of the risk scores between the current route and the alternative routes.

2. The method of claim 1, further comprising identifying whether the vehicle is an autonomous vehicle.

3. The method of claim 2, wherein calculating the risk score for each of the plurality of roadways or intersections is further based on the vehicle being an autonomous vehicle.

4. The method of claim 1, further comprising identifying a severity of an accident from the received data of the cameras.

5. The method of claim 4, wherein identifying the severity of the accident is based on the received data of the camera via post-accident reports, post accident reports coming from public or third-party data sources, or machine vision algorithms.

6. The method of claim 4, wherein calculating the risk scores comprises applying one or more weights corresponding to the identified severity of the accident.

7. The method of claim 1, further comprising receiving a user selection to proceed on one of the alternative routes instead of the current route.

8. The method of claim 1, wherein calculating the risk scores is further based on one or more of vehicle positions, vehicle speeds, quantity of vehicles, and timing.

9. A non-transitory computer-readable medium comprising instructions for performing a method of determining a vehicular insurance premium adjustment, the method comprising:
receiving data from cameras positioned at traffic signal indictors installed at a plurality of roadways or intersections, wherein the data corresponds to at least one instance of accident data and route data;
identifying a current route of a vehicle based on a current location of the vehicle and an identified destination;
identifying alternative routes for the vehicle, wherein the alternative routes are determined to start from the current location of the vehicle and end at the identify destination;
calculating risk scores for each of the plurality of roadways or intersections associated with the current route and the alternative routes of the vehicle, wherein the calculated risk score for each of the plurality of roadways or intersections is based at least on the accident data and the route data;
comparing the risk scores for each of the plurality of roadways or intersections associated with the current route of the vehicle with risk scores of alternative routes; and
sending a report regarding the risk scores for the current route and the alternative routes to an insurance network, wherein the insurance network determines vehicular insurance premium adjustments associated with the comparison of the risk scores between the current route and the alternative routes.

10. The non-transitory computer-readable medium of claim of claim 9, further comprising instructions executable to identify whether the vehicle is an autonomous vehicle.

11. The non-transitory computer-readable medium of claim of claim 10, wherein calculating the risk score for each of the plurality of roadways or intersections is further based on the vehicle being an autonomous vehicle.

12. The non-transitory computer-readable medium of claim of claim 9, further comprising instructions executable to identify a severity of an accident from the received data of the cameras

13. The non-transitory computer-readable medium of claim of claim 12, wherein identifying the severity of the accident is based on the received data of the camera via post-accident reports, post accident reports coming from public or third-party data sources, or machine vision algorithms.

14. The non-transitory computer-readable medium of claim of claim 12, wherein calculating the risk scores comprises applying one or more weights corresponding to the identified severity of the accident.

15. The non-transitory computer-readable medium of claim of claim 9, further comprising instructions executable to receive a user selection to proceed on one of the alternative routes instead of the current route.

16. The non-transitory computer-readable medium of claim of claim 9, wherein calculating the risk scores is further based on one or more of vehicle positions, vehicle speeds, quantity of vehicles, and timing.

17. A system for performing a method of determining a vehicular insurance premium adjustment, the system comprising:
cameras positioned at traffic signal indictors installed at a plurality of roadways or intersections, wherein the cameras capture data corresponding to at least one instance of accident data and route data;
a processor that executes instructions stored in memory, wherein execution of the instructions by the processor:
identifies a current route of a vehicle based on a current location of the vehicle and a pre-determined destination,
identifies alternative routes for the vehicle, wherein the alternative routes are determined to start from the current location of the vehicle and end at the pre-determined destination,
calculates risk scores for each of the plurality of roadways or intersections associated with the current and alternative routes of the vehicle, wherein the calculated risk score for each of the plurality of roadways or intersections is based at least on the accident data and the route data, and
compares the risk scores for each of the plurality of roadways or intersections associated with the current route of the vehicle with risk scores of alternative routes, and
a communication interface that send the risk scores of the current route and the alternative routes to an insurance network, wherein the insurance network determines vehicular insurance premium adjustments associated with the comparison of the risk scores between the current route and the alternative routes.
